(19) United States
(12) Patent Application Publication
(10) Pub. No.: US 2009/0127748 A1
(43) Pub. Date: May 21, 2009

(54) METHOD AND APPARATUS FOR PRODUCING NANOFIBERS AND POLYMERIC WEBS

(75) Inventor: Mitsuhiro Takahashi, Tokyo (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/300,693

(22) PCT Filed: Jul. 5, 2007
(86) PCT No.: PCT/JP2007/063876

§ 371 Date: Nov. 13, 2008

(30) Foreign Application Priority Data
Jul. 5, 2006 (JP) 2006-185833

(51) Int. Cl. B29C 47/66

(52) U.S. Cl. 264/465; 425/174.8 E

(57) ABSTRACT

A polymer solution that is prepared by dissolving a polymeric substance in a solvent is supplied into a cylindrical container serving as a rotating container having a plurality of small holes. The cylindrical container is driven to rotate by rotation drive means, and an electric field is applied by high voltage generating means to polymeric filaments discharged from the small holes so that they become electrically charged. Then, primary and secondary electrostatic explosions associated with the centrifugal force and the evaporation of the solvent take place, drawing the polymeric filaments and producing nanofibers made of the polymeric substance. These nanofibers are deposited to produce a polymeric web. Accordingly, by employing a simple structure, nanofibers and a polymeric web utilizing them can be produced evenly with excellent productivity.

### TECHNICAL FIELD

The present invention relates to a method and an apparatus for producing nanofibers made of polymeric substances and a highly porous polymeric web obtained by depositing those nanofibers.

### BACKGROUND ART

Conventionally, electrospinning (electric charge induced spinning) is known as a method for producing nanofibers made of polymeric substances and having a diameter in a submicron order. In the conventional electrospinning, a polymer solution is supplied to a needle nozzle to which a high voltage is applied so that the polymer solution discharged as filaments from this needle nozzle is electrically charged. As a solvent of the polymer solution evaporates, a distance between these electric charges decreases, and Coulomb force acting thereon increases. When this Coulomb force exceeds the surface tension of the filamentous polymer solution, the filamentous polymer solution undergoes what is called an electrostatic explosion where it is drawn explosively. This phenomenon repeats itself as primary, secondary, and sometimes tertiary explosions and so on, and accordingly, nanofibers made of polymers with a submicron diameter are obtained.

By depositing thus produced nanofibers on a substrate that is electrically grounded, a film having 3-D structure of 3-D mesh can be obtained, and by allowing this film to grow to be thicker, a highly porous web having submicron mesh can be produced. This highly porous web thus produced can be preferably used as a filter, a separator for use in a battery, a polymer electrolyte membrane or an electrode for use in a fuel cell, or the like. The application of the highly porous web made of these nanofibers is expected to dramatically improve the performance of those devices.

However, since, in the conventional electrospinning, only a plurality of nanofibers can be produced from the tip of a single nozzle, the productivity in producing highly porous polymeric webs cannot be improved as desired, and its production cannot be realized. Consequently, as a method for producing a polymeric web by forming a large amount of nanofibers, a method utilizing a plurality of nozzles has been proposed (see Japanese Patent Laid-open Publication No. 2002-201559).

With reference to FIG. 16, the structure of an apparatus for producing a polymeric web described in the above-mentioned Japanese Patent Laid-open Publication No. 2002-201559 is described as follows. A liquid polymeric substance in a barrel 43 is fed to a spinning unit 42 having a plurality of nozzles 41 by a pump 44. A high voltage of from 5 to 50 kV is applied to the nozzles 41 by a high voltage generating unit 45. Fibers discharged from the nozzles 41 are deposited on a collector 46 that is either grounded or charged to a polarity different from that of the nozzles 41 to form a web. The formed web is transported by the collector 46, and a polymeric web is produced, accordingly. It is also described in the document that a charge distributor 47 is disposed in the vicinity of the tips of the nozzles 41 to minimize electrical interference among the nozzles 41 and that a high voltage is applied to between the charge distributor 47 and the collector 46 so that an electric field which urges the charged fibers towards the collector 46 is created.

Furthermore, as shown in FIGS. 17A and 17B, it is also described in the document that, instead of providing a plurality of single nozzles, a plurality of multi-nozzles 41A, each including a plurality of nozzles 41, is provided to the spinning unit 42 such that a plurality of nanofibers is produced from each of the multi-nozzles 41A.

With regard to the melt spinning method, a method utilizing a centrifugal force has been previously known (see Japanese Patent Laid-open Publication No. Sho 58-114106). In this method, a rotating body provided with a number of holes for spinning on its circumference contains a polymer solution and is driven to rotate at high speed. Then, the centrifugal force initiates the spinning to produce fibers accordingly. However, this method had inherent technical difficulty in producing nanofibers and is only capable of producing fibers whose diameters are large compared to those of nanofibers of the submicron order. Accordingly, research and development have been centered on the above-mentioned electrospinning for many years as a method for producing nanofibers.

In order to produce the polymeric web with an improved productivity using the structure illustrated in FIG. 16, FIG. 17A, and FIG. 17B unchanged, it is conceivable that the nozzles 41 in the spinning unit 42 or the nozzles 41 in each multi-nozzle 41A are disposed at smaller intervals so that the number of nozzles per unit area is increased. In this case, however, as shown in FIG. 18, the polymeric substances discharged from each nozzle 41 repel each other as illustrated by arrows F since the polymeric substance is charged of the same polarity. Consequently, the discharge from the nozzles 41 located in the middle is hampered. Further to this, the discharge from the nozzles 41 located at a peripheral area is directed outward. As a result, the deposition distribution of nanofibers on the collector 46 becomes extremely sparse at the central area and concentrated at the peripheral area, thereby failing to produce a uniform polymeric web.

If a charge distributor 47 is disposed in the vicinity of the tips of the nozzles 41, electrical interference among the nozzles 41 is reduced as shown in FIG. 19. In addition to this, the polymeric substance discharged from each of the nozzles 41 is accelerated toward the collector 46 because an electric field E from the charge distributor 47 to the collector 46 is created. As a result, as compared to the case of FIG. 18, the deposition distribution of nanofibers at the central area and at the peripheral area can be uniformed to a certain extent. However, at the same time, the disposition pattern of the nozzles 41 is directly reflected in the deposition distribution. Therefore, the above-mentioned arrangement is not sufficiently effective in uniforming the deposition distribution.

Furthermore, if disposition density of the nozzles 41 is raised, fibers may come to be in contact each other and stick together without sufficiently evaporating the solvent. In addition to this, the concentration of the evaporated solvent may increase in the vicinity of the nozzles so that the insulation weakens, and accordingly, corona discharge takes place, thereby failing to form fibers.

Furthermore, if a number of nozzles 41 are to be disposed, it is difficult to supply a liquid polymeric substance evenly to each of the nozzles 41. This may complicate the structure of the apparatus and raise the cost of facility. In addition to this, in order to initiate an electrostatic explosion of the liquid polymeric substance discharged from the nozzles 41, the electric charge needs to be concentrated, and, accordingly, each of the nozzles 41 is formed in a long and narrow shape. However, it is also extremely difficult to conduct the maintenance on a number of long and narrow nozzles 41 in order to ensure that they are constantly in a proper condition.

The present invention has solved the conventional problems described above, and an object of the present invention is to provide a method and an apparatus for producing nanofibers and a polymeric web, which are capable of producing nanofibers and a polymeric web using these nanofibers uniformly with an excellent productivity using a simple structure.

### DISCLOSURE OF THE INVENTION

A method for producing nanofibers of the present invention includes the steps of: supplying a polymer solution, which is prepared by dissolving a polymeric substance in a solvent, into a rotating container having a plurality of small holes, at least a portion of which in the vicinity of the small holes possessing conductivity; rotating the rotating container; and applying an electric field to filaments of the polymer solution discharged from the small holes and allowing them to be drawn by a centrifugal force and an electrostatic explosion associated with an evaporation of the solvent to produce nanofibers made of the polymeric substance. It should be appreciated that, in the present invention, in order to apply an electric field to the filaments of the polymer solution discharged from the small holes of the rotating container, a large potential difference is applied between the rotating container and an object or a member that constitutes a space for forming nanofibers between itself and the rotating container. For example, when such an object or a member that constitutes a space for forming nanofibers between itself and the rotating container is either the earth or a member such as the collector grounded to the earth, a positive or negative high voltage with reference to the ground potential is applied to the rotating container. When a high voltage that is either positive or negative with reference to the ground potential is applied to a member such as the collector that constitutes a space for forming nanofibers between itself and the rotating container, the rotating container may be grounded or a high voltage of the opposite polarity may be applied to the rotating container. The small holes are not limited to those directly punched through the circumferential wall of the rotating container. Needless to say, the small hole may be provided by a nozzle member installed on or integrally molded with the circumferential wall of the rotating container. Also, the rotating container as a whole may possess conductivity. According to the present invention, the polymer solution is supplied into the rotating container such that the polymer solution forms a layer along the circumferential wall of the rotating container, whereby the polymer solution is discharged from the small holes by centrifugal force. This eliminates the need for applying pressure to the polymer solution, and simplifies the supply of the polymer solution to the rotating container.

According to the structure described above, a polymer solution is discharged as filaments from a plurality of small holes of the rotating container under the influence of the centrifugal force and is electrically charged by an applied electric field. When doing so, since the polymer solution is drawn first under the influence of the centrifugal force, the polymer solution is discharged from the small holes stably, and electrical interference hardly occur since the rotating container is rotated to discharge the polymer solution from the small holes radiately by the centrifugal force. Since electrical interference does not affect the condition, the polymer solution can be drawn reliably and effectively even if the small holes are densely disposed. Then, as the charged filaments of the polymer solution are further drawn by the centrifugal force with their diameters decreasing further and with the solvent evaporating, the electric charges start to concentrate. At the time when Coulomb force exceeds the surface tension, a primary electrostatic explosion takes place, and the polymer solution is explosively drawn. As the evaporation of the solvent proceeds further, a secondary electrostatic explosion takes place in a similar manner and the polymer solution is explosively drawn. A tertiary electrostatic explosion may take place, depending on the situation, so that the polymer solution is drawn further. Accordingly, nanofibers made of a polymeric substance and having a submicron diameter can be efficiently produced from a polymer solution discharged as filaments from a plurality of small holes.

Furthermore, since the small holes can be densely disposed as described above, a large amount of nanofibers can be efficiently produced using a simple and compact structure. Furthermore, since the polymer solution discharged from the small holes is first drawn by the centrifugal force, those small holes need not be made to be extremely small, whereby the polymer solution is discharged from the small holes stably to produce nanofibers uniformly. Thus, it is only necessary that the rotating container be simply provided with small holes. Hence, the rotating container can be fabricated easily and at low costs, and the maintenance can still be conducted easily even though there are a large number of small holes.

It is preferable that the rotating container be a cylindrical container that are provided with a plurality of small holes on its circumferential surface and rotates about its axis. Accordingly, a large amount of nanofibers can be produced at a time evenly from the entire circumference of the cylindrical container, and an excellent productivity can be ensured. Since is the shape and the structure are simple, the cost of facility can be reduced.

It is preferable that an amount of the polymer solution contained in the rotating container be controlled to be almost constant. By doing so, the centrifugal force that acts on the polymer solution discharged from the small holes of the cylindrical container becomes constant. Then, the polymer solution can be discharged evenly as filaments, and nanofibers can be produced evenly in the direction of the axis of the cylindrical container. One of the methods for controlling the constant amount is to detect an amount of the polymer solution contained in the rotating container, and to control the supply of the polymer solution into the rotating container so that an almost constant amount of polymer solution is maintained within the rotating container.

The rotation speed of the rotating container is preferably controlled based on the viscosity of the polymer solution contained in the rotating container. Accordingly, a desired centrifugal force in accordance with the viscosity of the polymer solution can be allowed to act on the polymer solution without changing the rotating container, thereby producing nanofibers both reliably and efficiently. When the viscosity of the polymer solution is high, produced nanofibers will be thick, and when the viscosity is low, produced nanofibers will be thin. Accordingly, the rotation speed of the rotating container is increased when the viscosity is high, and decreased when the viscosity is low.

The radial distance from the rotation axis of the rotating container to the small holes may be determined based on the viscosity of the polymer solution contained in the rotating container. Accordingly, a desired centrifugal force in accordance with the viscosity of the polymer solution can be allowed to act on the polymer solution without enormously varying the rotation speed of the rotating container, thereby reliably and efficiently producing nanofibers.

A method for producing a polymeric web in accordance with the present invention includes the step of depositing the nanofibers produced by the method for producing nanofibers described above. By depositing the nanofibers that are produced in large quantity as mentioned above, a highly porous polymeric web can be produced with excellent productivity.

It is preferable that the method include the steps of disposing a conductive collector with a certain distance with respect to the rotating container, applying a high voltage between the rotating container and the collector, and depositing nanofibers on the collector. Accordingly, electrically charged nanofibers move toward the collector and are deposited on the collector, thereby efficiently forming a polymeric web. The collector may have a function for successively transporting the polymeric web deposited thereon.

Furthermore, a sheet member on which nanofibers are to be deposited can be moved on and along the collector at a prescribed speed. Accordingly, sheets on which a polymeric web of a desired thickness is formed can be successively produced.

Furthermore, a reflecting electrode that is charged to the same polarity as that of the rotating container may be disposed in a range surrounding the rotating container except the area where the collector is disposed, so that nanofibers discharged and formed from the entire circumference of the rotating container are directed towards the collector. Accordingly, nanofibers that are discharged towards and formed around the entire circumference of the rotating container are disposed on the collector, thereby efficiently producing a polymeric web in a short period of time.

Furthermore, a plurality of collectors may be disposed at equal intervals around the rotating container, so that nanofibers discharged and generated from the entire circumference of the rotating container are directed to the respective collectors. Accordingly, nanofibers that are discharged towards and formed around the entire circumference can be collected and deposited on the respective collectors, thereby simultaneously producing a plurality of polymeric webs.

An apparatus for producing nanofibers in accordance with the present invention includes: a rotating container that is rotatably supported and is provided with a plurality of small holes disposed at a certain distance in a radial direction from a rotating axis; rotation drive means for driving the rotating container to rotate, at least a portion of which in the vicinity of the small holes possesses conductivity; high voltage generating means for applying a high voltage to the rotating container; polymer solution supply means for supplying a polymer solution, which is prepared by dissolving a polymeric substance in a solvent, into the rotating container; and a control unit for controlling the rotation drive means, the high voltage generating means, and the polymer solution supply means. While the rotating container is rotated at a prescribed speed by the control unit, the polymer solution is supplied into the rotating container, and a high voltage is applied to the rotating container. Because of this structure, the above-described method for producing nanofibers can be carried out, and its effect can be obtained.

Another apparatus for producing nanofibers in accordance with the present invention includes: a rotating container that is rotatably supported and is provided with a plurality of small holes disposed at a certain distance in a radial direction from the rotating axis, at least a portion of which in the vicinity of the small holes possesses conductivity; rotation drive means for driving the rotating container to rotate; a conductive collector that is disposed with a certain distance to the rotating container; high voltage generating means for applying a high voltage between the rotating container and the collector; polymer solution supply means for supplying a polymer solution, which is prepared by dissolving a polymeric substance in a solvent, into the rotating container; and a control unit that controls the rotation drive means, the high voltage generating means, and the polymer solution supply means. While the rotating container is rotated at a prescribed speed by the control unit, the polymer solution is supplied into the rotating container, and a high voltage is applied between the rotating container and the collector. Specifically, a high voltage may be applied to the rotating container, and the collector may be either grounded or applied with a high voltage of the opposite polarity to the rotating container. Alternatively, the rotating container may be grounded, and the collector may be applied with a positive or negative high voltage. Because of this structure, the similar effect can also be obtained.

It is preferable that the rotating container be composed of a cylindrical container having the plurality of small holes on the circumferential surface, and that control means for keeping an amount of the polymer solution contained in the cylindrical container constant be provided. Accordingly, a large amount of nanofibers can be produced evenly from the entire circumference of the cylindrical container at a time. As a result, high productivity can be secured, and, because of the simplicity in shape and configuration, the cost of equipment can be reduced. Furthermore, by controlling an amount of the polymer solution within the rotating container at a prescribed level, almost constant centrifugal force can be allowed to act on the polymer solution within the rotating container, thereby producing uniform nanofibers.

One of the methods for keeping an amount of polymer solution is to provide contained amount detecting means for detecting an amount of the polymer solution contained in the rotating container and supplied amount controlling means for controlling the polymer solution supply means based on the contained amount detected. Furthermore, the contained amount detecting means may be configured to include a protrusion that comes to make contact with the polymer solution within the rotating container when the polymer solution reaches a prescribed amount, and motor current detecting means for detecting a current flowing through a motor for driving the rotating container to rotate. In this instance, if an amount of the polymer solution within the rotating container reaches a prescribed amount, the polymer solution makes contact with the protrusion to increase the rotational resistance of the rotating container, and the motor current increases, thereby detecting the contained amount. As a result, the amount of the polymer solution can be controlled at a prescribed amount by providing a simple and inexpensive protrusion.

Furthermore, it is preferable that a single supply conduit or a plurality of supply pipes that supply a polymer solution to an axial unit of the cylindrical container be disposed, and that a plurality of material supply ports be disposed equidistantly in the axial direction by utilizing this single supply conduit or the plurality of supply pipes, so that the polymer solution is supplied almost evenly into the cylindrical container along its axial direction. Accordingly, centrifugal force acts evenly on the polymer solution to be discharged from respective small holes arranged along the axial direction of the cylindrical container, and the polymer solution can be discharged evenly as filaments, thereby producing nanofibers evenly along the axis of the cylindrical container.

An apparatus for producing a polymeric web in accordance with the present invention produces a polymeric web by depositing nanofibers produced by the another apparatus for producing nanofibers described above on a two-dimensionally extending collector. Accordingly, nanofibers produced as described above are deposited on the collector, thereby efficiently producing a polymeric web.

It is preferable that sheet member moving means for moving a sheet member, on which nanofibers are deposited, at a prescribed speed on and along the collector be provided. Accordingly, a sheet on which a polymeric web of a prescribed thickness is formed can be produced successively.

Furthermore, a reflecting electrode that is charged to the same polarity as that of the rotating container can be disposed in a range surrounding the rotating container except an area where the collector is disposed. Accordingly, nanofibers discharged and formed around the entire circumference of the rotating container are repelled by the electric charge of the reflecting electrode of the same polarity, and are directed towards and deposited on the collector, thereby producing a polymeric web efficiently in a short period of time.

Furthermore, a plurality of collectors may be disposed equidistantly around the rotating container. Accordingly, nanofibers discharged and formed around the entire circumference of the rotating container can be collected and deposited on each of the collectors, thereby producing a plurality of polymeric webs.

### BRIEF DESCRIPTION OF THE DRAWINGS

FIG. 1 is an explanatory diagram illustrating a principle of a method for producing nanofibers of the present invention.

FIG. 2 is a perspective view illustrating a general structure of embodiment 1 of an apparatus for producing a polymeric web of the present invention.

FIG. 3 is a vertical cross sectional view illustrating the general structure of embodiment 1.

FIG. 4 is a perspective view of another example of the rotating container in embodiment 1.

FIG. 5 is a cross sectional view illustrating another example of a structure for evenly supplying a polymer solution into the rotating container in embodiment 1.

FIG. 6 is a partial cross sectional view illustrating one example of the polymer solution supply means in embodiment 1.

FIGS. 7A and 7B are explanatory diagrams illustrating two examples of the arrangement of the small holes on the cylindrical container of embodiment 1.

FIG. 8 is a vertical cross sectional view illustrating a general structure of embodiment 2 of an apparatus for producing a polymeric web of the present invention.

FIG. 9 is a vertical cross sectional front view illustrating a general structure of embodiment 3 of an apparatus for producing a polymeric web of the present invention.

FIG. 10 is a vertical cross sectional front view illustrating a general structure of embodiment 4 of an apparatus for producing a polymeric web of the present invention.

FIG. 11 is a block diagram illustrating a control structure of embodiment 4.

FIG. 12 is an explanatory diagram illustrating control operations for an amount of the polymer solution in embodiment 4.

FIG. 13 is a vertical cross sectional side view illustrating a general structure of embodiment 5 of an apparatus for producing a polymeric web of the present invention.

FIG. 14 is a vertical cross sectional side view illustrating another example of a structure of embodiment 5.

FIG. 15 is a vertical cross sectional side view illustrating a general structure of embodiment 6 of an apparatus for producing a polymeric web of the present invention.

FIG. 16 is a diagram illustrating a general structure of an apparatus for producing a polymeric web of a conventional example.

FIGS. 17A and 17B illustrate essential parts of another example of a structure of the conventional example, FIG. 17A being a front view, and FIG. 17B being a partially enlarged bottom view.

FIG. 18 is a diagram illustrating problems faced in the conventional example.

FIG. 19 is a diagram illustrating still other problems faced in the conventional example.

### BEST MODE FOR CARRYING OUT THE INVENTION

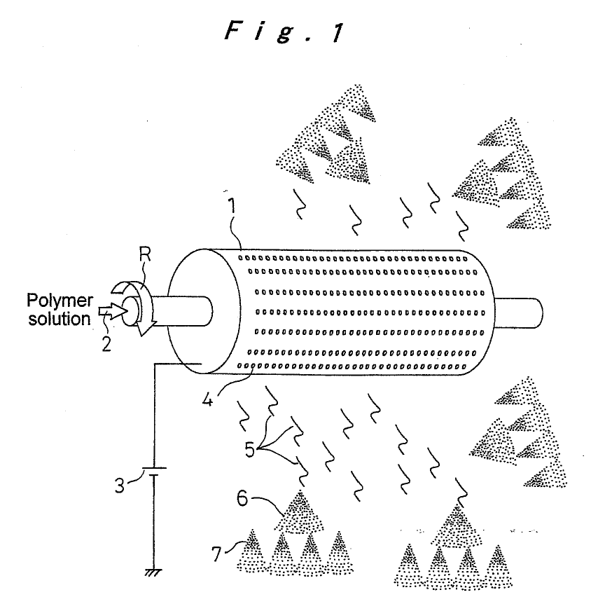

In the following paragraphs, each embodiment of the method and apparatus for producing nanofibers and a polymeric web of the present invention will be described with reference to FIGS. 1 to 15.

### Embodiment 1

Embodiment 1 of a method and an apparatus for producing a polymeric web will be described with reference to FIGS. 1 to 7B.

FIG. 1 is an explanatory diagram illustrating a principle of a method for producing nanofibers, the method being applied to a method for producing a polymeric web of the present embodiment. In FIG. 1, reference numeral 1 designates a cylindrical container, as a rotating container, having a diameter of 20 to 500 mm. The rotating container is driven to rotate at a rate of 30 to 6000 rpm about the rotation axis as shown by an arrow R. The rotating container 1 is supplied with a polymer solution 2 from one end thereof. In this instance, the polymer solution is obtained by dissolving a polymeric substance, which is a material for the nanofibers, in a solvent.

Examples of polymeric substances constituting polymer solution 2 include polypropylene, polyethylene, polystyrene, polyethylene oxide, polyethylene terephthalate, polybutylene terephthalate, polyethylene naphthalate, poly-m-phenylene terephthalate, poly-p-phenylene isophthalate, polyvinylidene fluoride, polyvinylidene fluoride-hexafluoropropylene copolymer, polyvinyl chloride, polyvinylidene chloride-acrylate copolymer, polyacrylonitrile, polyacrylonitrile-methacrylate copolymer, polycarbonate, polyarylate, polyester carbonate, nylon, aramid, polycaprolactone, polylactic acid, polyglycolic acid, collagen, polyhydroxybutyric acid, polyvinyl acetate, and polypeptide. Although at least one type selected from the above is used, the present invention should not be limited thereto.

Solvents that can be used include methanol, ethanol, 1-propanol, 2-propanol, hexafluoroisopropanol, tetraethylene glycol, triethylene glycol, dibenzyl alcohol, 1,3-dioxolane, 1,4-dioxane, methyl ethyl ketone, methyl isobutyl ketone, methyl-n-hexyl ketone, methyl-n-propyl ketone, diisopropyl ketone, diisobutyl ketone, acetone, hexafluoroacetone, phenol, formic acid, methyl formate, ethyl formate, propyl formate, methyl benzoate, ethyl benzoate, propyl benzoate, methyl acetate, ethyl acetate, propyl acetate, dimethyl phthalate, diethyl phthalate, dipropyl phthalate, methyl chloride, ethyl chloride, methylene chloride, chloroform, o-chlorotoluene, p-chlorotoluene, carbon tetrachloride, 1,1-dichloroethane, 1,2-dichloroethane, trichloroethane, dichloropropane, dibromoethane, dibromopropane, methyl bromide, ethyl bromide, propyl bromide, acetic acid, benzene, toluene, hexane, cyclohexane, cyclohexanone, cyclopentane, o-xylene, p-xylene, m-xylene, acetonitrile, tetrahydrofuran, N,N-dimethylformamide, pyridine, and water. Although at least one type selected from the above is used, the present invention should not be limited thereto.

The polymer solution can be mixed with an inorganic solid material, examples of which include oxides, carbides, nitrides, borides, silicides, fluorides, and sulfides. However, in terms of thermal stability, workability, and the like, oxides are preferable. Examples of oxides include Al₂O₃, SiO₂, TiO₂, Li₂O, Na₂O, MgO, CaO, SrO, BaO, B₂O₃, P₂O₅, SnO₂, ZrO₂, K₂O, Cs₂O, ZnO, Sb₂O₃, As₂O₃, CeO₂, V₂O₅, Cr₂O₃, MnO, Fe₂O₃, CoO, NiO, Y₂O₃, Lu₂O₃, Yb₂O₃, HfO₂, and Nb₂O₅. Although at least one type selected from the above is used, the present invention should not be limited thereto.

The rotating container 1 is configured such that a high voltage of 1 to 100 kV is applied by high voltage generating means and the polymer solution 2 contained therein is subjected to this high voltage. The cylindrical container 1 has a number of small holes 4 of 0.1 to 2 mm in diameter provided on its circumferential surface at intervals of a few millimeters. Hence, when the cylindrical container 1 is driven to rotate at a high speed, the centrifugal force acts on the polymer solution 2, which is in turn discharged as filaments from each of the small holes 4. The filaments of polymer solution 2 are then drawn under the influence of the centrifugal force to become fine polymeric filaments 5. These polymeric filaments 5 are then subjected to an electric field that is created around the rotating container 1 to which a high voltage is applied, and are electrically charged.

When these polymeric filaments 5 are further drawn under the influence of the centrifugal force and the solvent evaporates, the diameter of the polymeric filament 5 decreases and the electric charge residing thereon becomes concentrated. When Coulomb force exceeds the surface tension of the polymer solution, a primary electrostatic explosion 6 takes place, and the polymeric filament is explosively drawn. Then, as the solvent further evaporates, a secondary electrostatic explosion 7 takes place, and the polymeric filament 5 is further drawn in a similar manner. Depending on the condition, a tertiary electrostatic explosion and so on may take place. Consequently, nanofibers that have submicron diameters and are made of a polymeric substance are efficiently produced. In the primary electrostatic explosion 6, the filament is explosively drawn, spiraling in a conic form with an apex being located at the start point of the explosion. The secondary electrostatic explosion 7 follows basically the same pattern with other disrupting factors, resulting in explosive elongation in a more complicate manner. FIG. 1 schematically illustrates such processes.

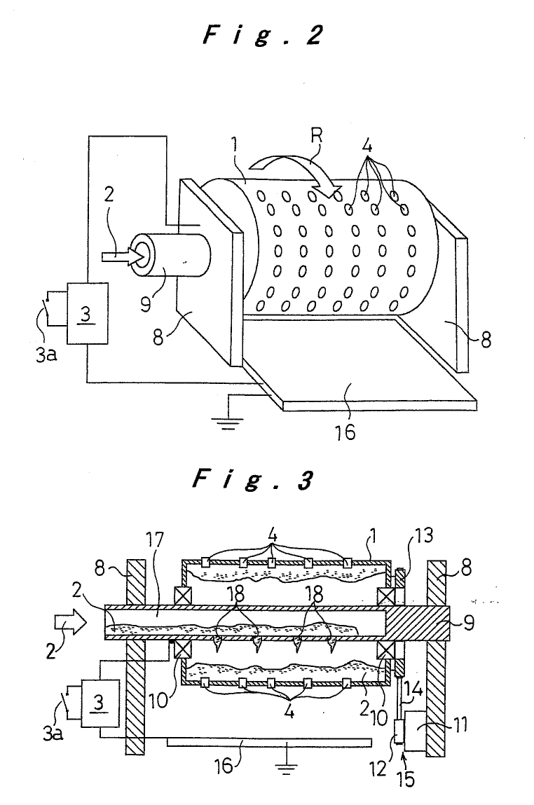

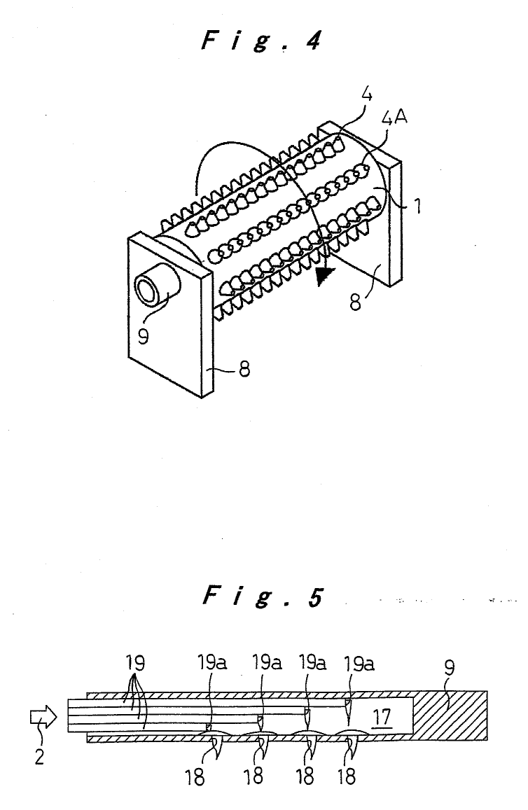

An apparatus for producing a polymeric web of the present embodiment, to which the above-described method for producing nanofibers is applied, has a basic structure as illustrated in FIGS. 2 and 3. A cylindrical container 1 is rotatably supported about its axis by support members 8 provided on respective sides of that axis. Specifically, both ends of a center shaft 9 that penetrates through the axial unit of the cylindrical container 1 are secured on the respective support members 8, and the cylindrical container 1 is rotatably supported by bearings 10 around the center shaft 9. The support member 8 that faces one end of the cylindrical container 1 is provided with a drive motor 11 on the inside surface thereof. Between a driving pulley 12 secured on the output shaft of the motor and a driven pulley 13 secured on the circumference of one end of the cylindrical container 1, a belt 14 is wound around. Accordingly, the cylindrical container 1 is configured such that it is driven to rotate in the direction indicated by an arrow R in FIG. 2 by rotation drive means 15 consisting of the drive motor 11, the driving pulley 12, the driven pulley 13, and the belt 14. The small holes 4 of the cylindrical container 1 may be formed by directly punching through the circumferential wall of the cylindrical container 1. Preferably, the small holes 4 are provided by a nozzle member 4A, which has a hole serving as the small hole 4, installed on or integrally molded with the circumferential wall of the cylindrical container 1 as shown in FIG. 4.

A conductive planar collector 16 is provided between the support members 8. The collector 16 spreads two-dimensionally below and facing the cylindrical container 1 with a certain distance thereto being maintained and is electrically grounded. High voltage generating means 3 is interposed between the collector 16 and the cylindrical container 1 to apply a high voltage to the cylindrical container 1. The high voltage generating means 3 also creates a large potential difference between the cylindrical container 1 and the collector 16 so that charged nanofibers move toward the collector 16 to be deposited thereon. Here, instead of having the collector 16 grounded, a voltage with a polarity opposite to that of the cylindrical container 1 may be applied. It is preferable that the high voltage generating means 3 have an output voltage of 1 to 100 kV and be arbitrarily turned on and off by a switch 3a. Furthermore, it is preferable that the center shaft 9 be insulated and that the voltage applied by the high voltage generating means 3 to the cylindrical container 1 be supplied through a stationary part of the bearings 10 with respect to the center shaft 9. The high voltage generating means 3 applies a positive voltage to the cylindrical container 1 in the above example, but a negative voltage may be applied to the cylindrical container 1 in which case the polarity of electrical charge is opposite. In addition, the cylindrical container 1 may be grounded and a high voltage may be applied to the collector 16.

The center shaft 9 is made of a hollow shaft with one end being closed, and its hollow part serves as a supply conduit 17 for the polymer solution 2. The center shaft 9 is provided at its bottom with material supply ports 18 arranged at appropriate intervals in the axis direction, and a prescribed amount of polymer solution 2 is almost evenly supplied into the cylindrical container 1 from these material supply ports 18. Therefore, the material supply ports 18 may be designed such that their aperture sizes successively increase from the open end side to the closed end side of the supply conduit 17. Furthermore, as illustrated in FIG. 5, a plurality of supply pipes 19 may be inserted in the supply conduit 17 in such a manner that an exit aperture 19a of each supply pipe 19 corresponds to one of the material supply ports 18 so that the polymer solution 2 is supplied to the material supply ports 18 more evenly and reliably.

FIG. 6 illustrates a preferable example of a structure of polymer solution supply means 20 for supplying the polymer solution 2 towards the supply conduit 17 of the center shaft 9. In FIG. 6, the polymer solution 2 obtained by dissolving a polymeric substance in a solvent is contained in a solution tank 21, from which the solution is supplied to an air-tight insulating intermediate container 23 by a gear pump 22. A compressed air source (not shown in the figure) supplies compressed air to the insulating intermediate container 23 through an air regulator 24, thereby pressing down on the surface of the polymer solution 2. The polymer solution 2 is thus supplied to the supply conduit 17 or the supply pipes 19 through a transport pipe 25 inserted into the bottom of the insulating intermediate container 23. This structure ensures that the high voltage applied to the cylindrical container 1 be prevented from leaking out to the gear pump 22 side through the polymer solution 2. When insulation against the cylindrical container 1 is secured, the polymer solution 2 may be simply and directly supplied to the supply conduit 17 or the supply pipes 19 from the solution tank 22 by the gear pump 22.

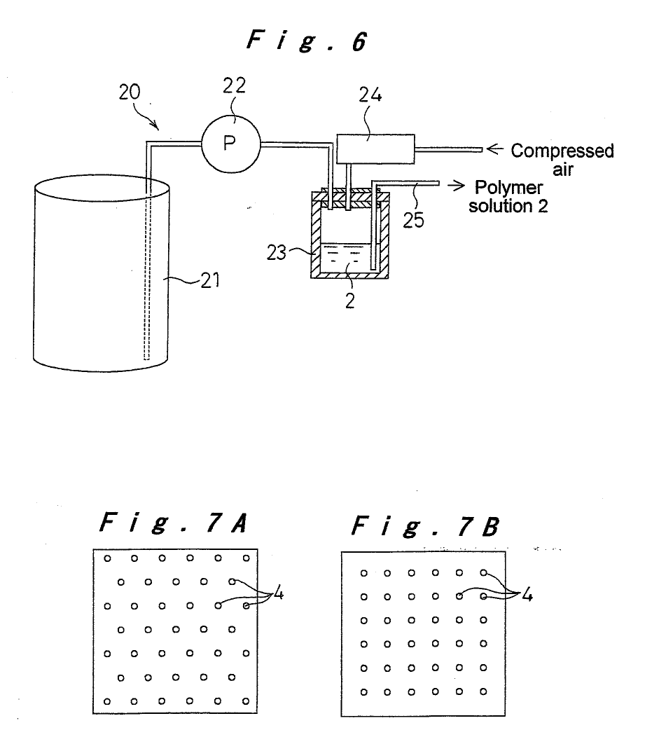

If the small holes 4 formed on the circumferential surface of the cylindrical container 1 are arranged to be at apexes of equilateral triangles that spread in a two-dimensionally continuous pattern as shown in FIG. 7A, then a distance between any two neighboring small holes 4 becomes constant, and the polymeric filaments 5 and, consequently, the nanofibers, can preferably be discharged and formed in a two-dimensionally uniform manner. Alternatively, as shown in FIG. 7B, they may be arranged in a matrix where they are at equidistant positions both in the circumferential and axial directions.

In the above-described structure, a prescribed amount of the polymer solution 2 is supplied into the cylindrical container 1 by the polymer solution supply means 20, and a prescribed high voltage is applied to the cylindrical container 1 by the high voltage generating means 3. As a result, the polymer solution 2 contained in the cylindrical container 1 is subjected to the high voltage. Then, in this condition, by making the cylindrical container 1 rotate at a high speed by the rotation drive means 15, the polymer solution 2 is discharged as filaments from a plurality of small holes 4, thereby forming the polymeric filaments 5. These polymeric filaments 5 are drawn significantly by the centrifugal force and become electrically charged under the influence of an electric field surrounding the cylindrical container 1. Then, as the polymeric filament 5 is further drawn by the centrifugal force with the diameter becoming smaller and smaller and the solvent evaporates, the primary electrostatic explosion takes place and the elongation proceeds explosively. As the solvent evaporates further, the secondary electrostatic explosion takes place in a similar manner, and the elongation proceeds explosively further. Depending on the condition, the tertiary electrostatic explosion takes place, and the elongation proceeds further. As a result, nanofibers made of a polymeric substance and having a submicron diameter are produced from the polymeric filaments 5 discharged from the plurality of small holes 4. Thus produced and electrically charged nanofibers move towards the collector 16 and are deposited on the collector 16. Accordingly, a highly porous polymeric web can be produced with high productivity.

In this instance, since the polymeric filament 5 formed when discharged from the small hole 4 of the cylindrical container 1 is first drawn largely by the centrifugal force, the small hole 4 does not need to be made extremely small but can be made to be approximately 0.1 to 2 mm in diameter. Furthermore, since electric charge does not need to be concentrated as it would be in the case where the electrostatic explosion must take place first, the small hole 4 does not need to be formed as a long and narrow nozzle. Furthermore, since the electric field interference does not affect the situation, even when the small holes 4 are densely arranged, the polymeric filaments can reliably and efficiently drawn, thereby producing efficiently a large amount of nanofibers in a simple and compact structure. Furthermore, a large amount of nanofibers can be produced at a time evenly from the entire circumference of the cylindrical container 1, ensuring high productivity. Its simple shape and structure also contribute to a cost reduction associated with production facilities. Furthermore, since the small holes 4 do not need to be made of a long shape, these small holes 4 can be simply provided circumferentially on the outside of the cylindrical container 1. Their fabrication is easy and less expensive, and maintenance can be carried out easily even if a number of small holes 4 are provided.

The rotation drive means 15 is configured such that the rotation speed of the cylindrical container 1 can be controlled based on the viscosity of the polymer solution 2 contained in the cylindrical container 1. Because of this structure, a required centrifugal force that acts on the polymer solution 2 can be produced in accordance with the viscosity of the polymer solution 2, thereby reliably and efficiently producing nanofibers. When the viscosity is high, diameters of nanofibers being produced become large, and when the viscosity is low, they become small. Hence, the rotation is controlled such that the rotation speed of the rotating container 1 is increased when the viscosity becomes high and decreased when the viscosity becomes low. For a composition of a given polymer solution, the relationship among its viscosity, the rotation speed, and the diameters of nanofibers being produced can be determined in advance by experiment. Therefore, if the viscosity of the polymer solution is measured, the optimum rotation speed for that solution can be calculated. Then, by controlling to achieve this optimum rotation speed, nanofibers that evenly have the desired diameters can be produced. Furthermore, since the radius of the cylindrical container 1 is also determined based on the viscosity of the polymer solution 2 to be contained in the cylindrical container 1, the required centrifugal force can be produced in accordance with the viscosity of the polymer solution 2 without enormously changing the rotation speed.

### Embodiment 2

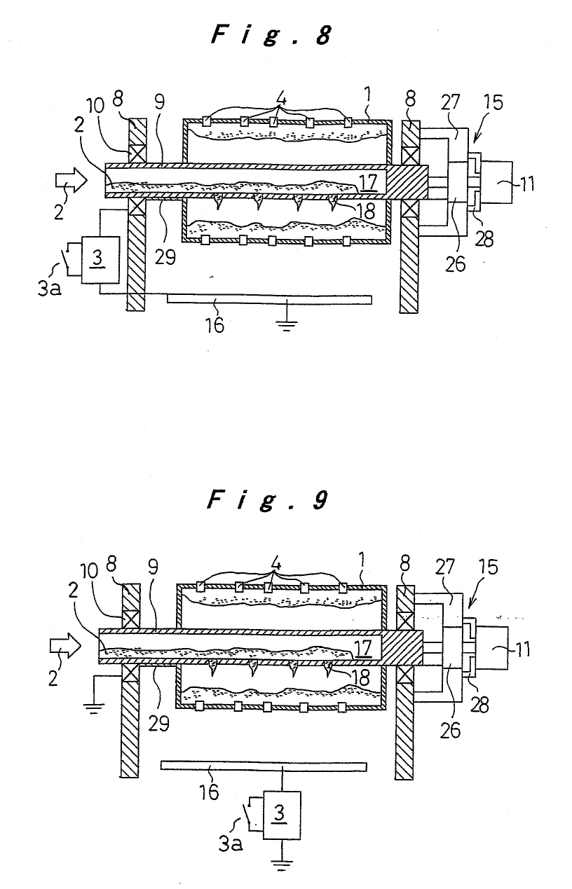

Next, embodiment 2 concerning a method and an apparatus for producing a polymeric web of the present invention will be described with reference to FIG. 8. In the following description of the embodiment, the same components as appeared in the preceding embodiment will be designated by the same reference numerals, and descriptions of those components will be omitted while only differences will be described.

In the above-described embodiment, an example was illustrated where the center shaft 9 was secured on the support members 8, and the cylindrical container 1 is rotatably supported by the bearings 10 around this center shaft 9. However, in the present embodiment, the cylindrical container 1 is secured onto the center shaft 9, and both ends of the center shaft 9 are rotatably supported by the support members 8 with the bearings 10 interposed therebetween as illustrated in FIG. 8. Accordingly, the rotation drive means 15 is configured such that the output shaft of the drive motor 11 is connected to one end of the center shaft 9 with a speed reducer 26 interposed therebetween, and the speed reducer 26 is attached to the support member 8 with a fixture bracket 27. The drive motor 11 is attached to the fixture bracket 27 by a fixture bracket 28. Furthermore, the high voltage generating means 3 is connected to the stationary side of the bearings 10 that are provided to the support member 8. The rotating side of the bearings 10 and the cylindrical container 1 are connected with each other by a conductive member 29, so that the center shaft 9 is held electrically insulated.

According to the present embodiment, since only the rotation drive mechanism for the cylindrical container 1 is different and the basic structure remains the same as in the first embodiment, similar function and effect can be obtained. It should be appreciated that, since the center shaft 9 rotates in the present embodiment, a rotary joint (not shown in the figure) is interposed between the polymer solution supply means 20 and the center shaft 9.

### Embodiment 3

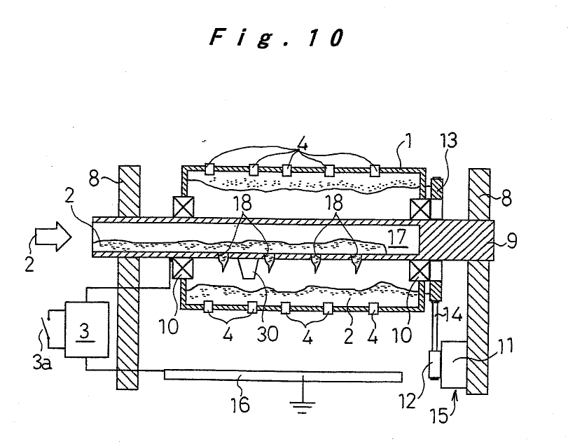

Next, embodiment 3 concerning a method and an apparatus for producing a polymeric web of the present invention will be described with reference to FIG. 9.

In the above-described embodiments, examples were illustrated in which a high voltage with respect to the ground potential generated by the high voltage generating means 3 was applied to the cylindrical container 1, with the collector 16 being maintained at the ground potential. However, in the present embodiment, a high voltage that is either positive or negative and generated by the high voltage generating means 3 is applied to the collector 16, and the cylindrical container 1 is grounded through the conductive member 29 and the bearings 10.

In the present embodiment, too, the polymeric filaments 5 are discharged from the cylindrical container 1 that is maintained at a high voltage either positively or negatively relative to the collector 16. Then, a polymer solution forming these polymeric filaments 5 becomes electrically charged by an electric field created between the cylindrical container 1 and the collector 16 and undergoes an electrostatic explosion. Consequently, nanofibers are efficiently produced similarly as described above and move towards the collector 16 under the influence of an electric field between the cylindrical container 1 and the collector 16 to be deposited on the collector 16 as a polymeric web. In the present embodiment, since only the collector 16 is maintained at a high voltage relative to the ground potential while the cylindrical container 1 to which the rotation drive means 15 and the polymer solution supply means 20 are connected is at the ground potential, electrical insulation can easily be secured, and the safety can advantageously be assured with a simple structure.

### Embodiment 4

Next, embodiment 4 concerting a method and an apparatus for producing a polymeric web of the present invention will be described with reference to FIGS. 10 to 12.

In the above-described embodiments, examples were described in which a prescribed amount of polymer solution 2 was supplied into the cylindrical container 1 based on planned production of the polymeric web. However, in the present embodiment, an amount of polymer solution 2 contained in the cylindrical container 1 is detected, and the operation of the polymer solution supply means 20 is controlled based on the detected amount, so that an almost constant amount of polymer solution 2 is maintained within the rotating container 1.

As illustrated in FIG. 10, the basic structure of the present embodiment is the same as that of the first embodiment except that a protrusion 30 extending downward toward the inner circumference of the cylindrical container 1 is provided on the stationary center shaft 9, such that, when the polymer solution 2 contained in the cylindrical container 1 reaches a prescribed amount, the liquid surface of the polymer solution 2 makes contact with this protrusion 30. When the polymer solution 2 makes contact with the protrusion 30, the rotational resistance of the cylindrical container 1 becomes large, and a motor current flowing through the drive motor 11, whish is controlled so that the cylindrical container 1 rotates at a prescribed speed, increases. Accordingly, by detecting this motor current, it can be detected that the polymer solution 2 has reached the prescribed amount.

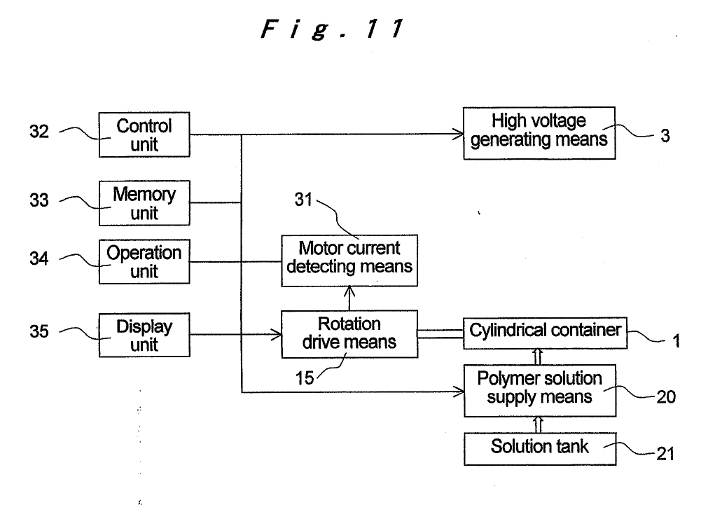

Therefore, motor current detecting means 31 that detects the motor current of the drive motor 11 of the rotation drive means 15 is provided. Then, the detected signal is sent to a control unit 32, and this control unit 32 controls the operation of the polymer solution supply means 20. In FIG. 11, the control unit 32 controls the operations of the high voltage generating means 3, the rotation drive means 15, and the polymer solution supply means 20, based on control programs stored in a memory unit 33 in advance, a variety of control data inputted from an operation unit 34, input signals from a variety of sensors (not shown in the figure) provided to the respective means, and operation instructions by the operation unit 34. Statuses of these operations are displayed on a display unit 35.

With such a structure described above, it follows that, as the polymer solution 2 is kept being supplied into the cylindrical container 1 by the polymer solution supply means 20, the polymer solution 2 increases in volume, and at the same time, the motor current gradually increases, as shown in FIG. 12. Passing the condition at T1, as the level of the polymer solution 2 starts making contact with the protrusion 30, the motor current suddenly increases. If the level of the polymer solution 2 reaches L1 at T2 and the protrusion 30 makes steady contact with the polymer solution 2, then the motor current reaches C1. This turns off the action of the polymer solution supply means 20, thereby stopping the supply of the polymer solution 2. Subsequently, the polymer solution 2 within the cylindrical container 1 gradually decreases in volume as the polymeric web is being produced, and when the level of the polymer solution 2 comes down to L2 at T3 and the protrusion 30 is separated away from the polymer solution 2, the motor current decreases to C2. Then, a supply action of the polymer solution 2 by the polymer solution supply means 20 is carried out. Subsequently, by repeating the respective actions performed at T2 and T3, the amount of the polymer solution 2 within the cylindrical container 1 is always maintained at an almost constant level.

According to the present embodiment, since the polymer solution 2 within the cylindrical container 1 can be controlled to be of a prescribed amount by providing a simple and inexpensive structure, namely, the protrusion 30, a constant centrifugal force can be produced to act on the polymer solution 2 within the cylindrical container 1. Then, the centrifugal force acting on the polymer solution 2 discharged from the small holes 4 of the cylindrical container 1 becomes constant, and the polymer solution 2 can be evenly discharged as a number of filaments, thereby evenly producing nanofibers and polymeric webs.

### Embodiment 5

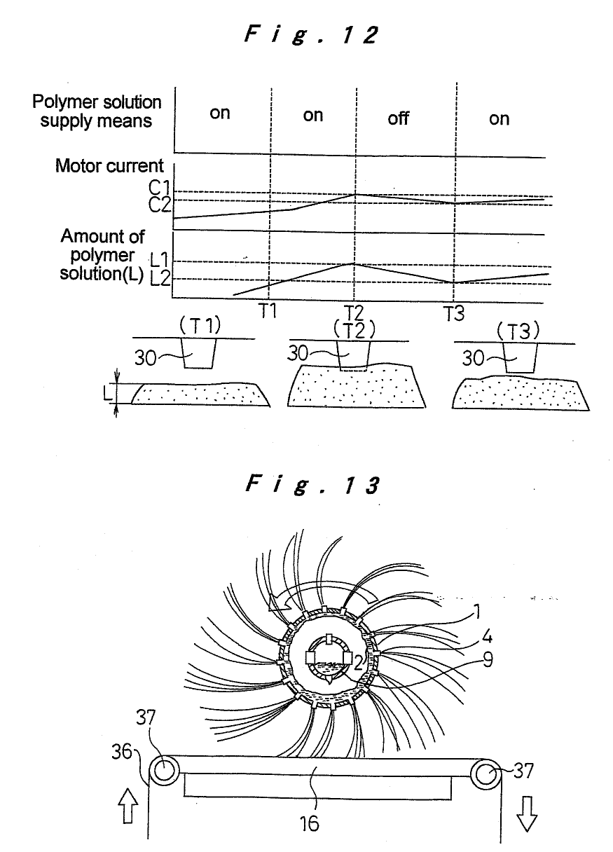

Next, embodiment 5 concerning a method and an apparatus for producing a polymeric web of the present invention will be described with reference to FIGS. 13 and 14.

In the above-described embodiments, examples were described where nanofibers were deposited on the collector 16. Polymeric webs formed on the collector 16 were collected, or a member that was designed to receive polymeric webs was disposed on the collector 16 so that the polymeric webs were formed thereon and collected accordingly. However, in the present embodiment, sheet member moving means 37 is provided that moves a sheet member 36 onto which nanofibers are to be deposited on and along the collector 16 at a prescribed speed as illustrated in FIG. 13. With this structure, a sheet on which the polymeric web of a desired thickness is formed can be produced successively.

Furthermore, in another example of the present embodiment, a plurality (four in the figure) of collectors 16 and sheet member moving means 37 are equidistantly arranged so as to surround the entire cylindrical container 1 as shown in FIG. 14. Nanofibers discharged and formed from the entire circumference of the cylindrical container 1 are directed towards the respective collectors 16, and the polymeric webs are successively formed on the sheet member 36 that is being moved at a prescribed speed by the sheet member moving means 37. With this structure, a plurality of polymeric webs can be produced from the nanofibers that are discharged and formed around the entire circumference of the cylindrical container 1.

### Embodiment 6

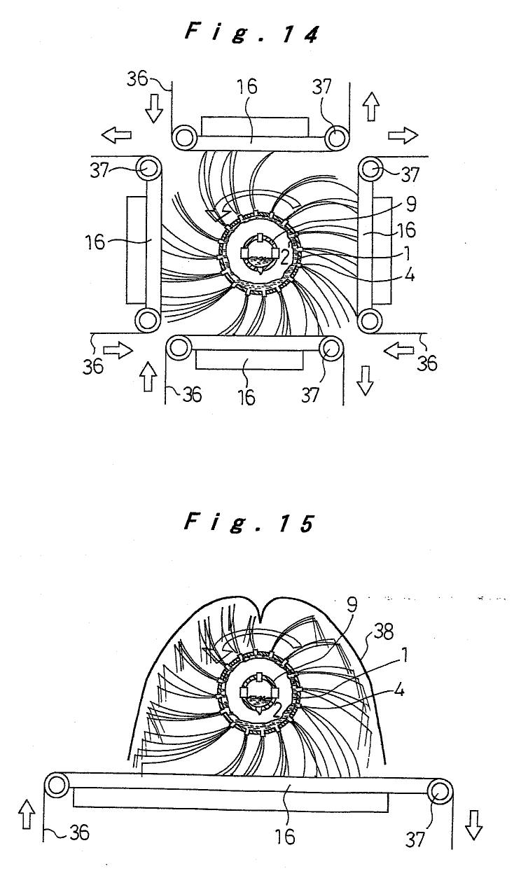

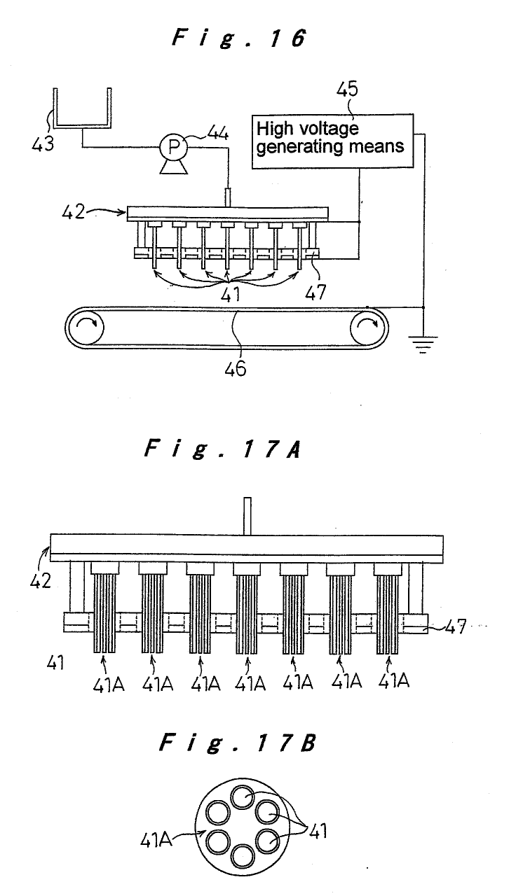

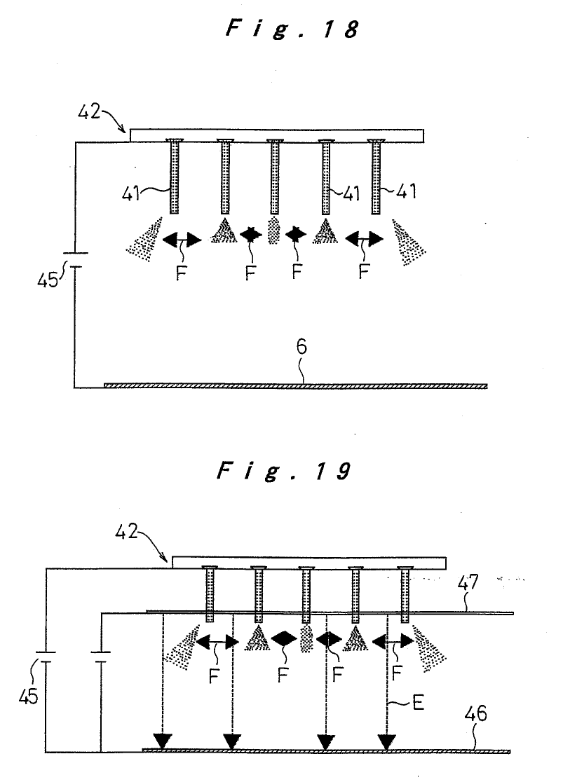

Next, embodiment 6 concerning a method and an apparatus for producing a polymeric web of the present invention will be described with reference to FIG. 15.

In the above-described embodiments, examples were described in which nanofibers were collected and deposited only on a single collector 16 disposed on one side of the cylindrical container 1 as illustrated in FIG. 13, or a plurality of collectors 16 is arranged around the cylindrical container 1 so that nanofibers were collected and deposited on the entire circumference thereof as illustrated in FIG. 14. However, in the present embodiment, a single collector 16 is disposed on one side of the cylindrical container 1, and a reflecting electrode 38 that is charged to the same polarity as the cylindrical container 1 is provided in an area surrounding the cylindrical container 1 except the area where the collector 16 is disposed. It is preferable that the reflecting electrode 38 be made of a net electrode so that the vaporized solvent diffuses out smoothly. Its shape is designed such that the direction of reflection is always toward the collector 16 no matter where the reflection takes place.

According to the present embodiment, nanofibers that are discharged and formed from the entire circumference of the cylindrical container 1 are reflected because they are repelled by the electric charge of the same polarity residing on the reflecting electrode 38, and hence, are surely directed towards the collector 16 and deposited on the sheet member 36 moving on and along the collector 16. Therefore, a polymeric web can be efficiently produced in a short period of time from the nanofibers that are discharged and formed around the entire circumference of the cylindrical container 1.

Although, in each of the above embodiments, the cylindrical container 1 was described as a rotating container that is driven to rotate about its axis, the cylindrical container 1 is not limited to such a rotating container. As long as a container is capable of accepting a polymer solution 2, rotating, and discharging the polymer solution 2 from small holes 4 because of the centrifugal force to form polymeric filaments 5, it can be formed into an arbitrary shape.

### INDUSTRIAL APPLICABILITY

According to a method and an apparatus for producing nanofibers and a polymeric web of the present invention, nanofibers having a submicron diameter can be efficiently produced from a polymer solution discharged as filaments from a plurality of small holes provided on a rotating container, and, by having those being deposited, a polymeric web can be produced. Accordingly, the present invention can be preferably utilized in the production of highly porous webs that are preferably used as a filter, a separator for use in a battery, a polyelectrolyte membrane or an electrode for use in a fuel cell, or the like.

1. A method for producing nanofibers, comprising:
supplying a polymer solution, which is prepared by dissolving a polymeric substance in a solvent, into a rotating container having a plurality of small holes, at least a portion of the rotating container, in the vicinity of the small holes, possessing conductivity;
rotating the rotating container; and
applying an electric field to filaments of the polymer solution discharged from the small holes and allowing them to be drawn by a centrifugal force and an electrostatic explosion associated with an evaporation of the solvent to produce nanofibers made of the polymeric substance.

2. The method for producing nanofibers according to claim 1, wherein the rotating container is a cylindrical container that are provided with the plurality of small holes on a circumferential surface thereof and rotates about an axis thereof.

3. The method for producing nanofibers according to claim 1, including controlling an amount of the polymer solution contained in the rotating container to be almost constant.

4. A method for producing a polymeric web, comprising the step of depositing the nanofibers produced by the method for producing nanofibers according to claim 1.

5. The method for producing a polymeric web according to claim 4, comprising the steps of:
disposing a conductive collector with a certain distance with respect to the rotating container;
applying a high voltage between the rotating container and the collector; and
depositing nanofibers on the collector.

6. An apparatus for producing nanofibers or a polymeric web, comprising:
a rotating container that is rotatably supported and is provided with a plurality of small holes disposed at a certain distance in a radial direction from a rotating axis, at least a portion of the rotating container, in the vicinity of the small holes, possessing conductivity;
rotation drive means for driving the rotating container to rotate;
high voltage generating means for applying a high voltage to the rotating container;
polymer solution supply means for supplying a polymer solution, which is prepared by dissolving a polymeric substance in a solvent, into the rotating container; and
a control unit for controlling the rotation drive means, the high voltage generating means, and the polymer solution supply means, wherein
while the rotating container is rotated at a prescribed speed by the control unit, the polymer solution is supplied into the rotating container, and a high voltage is applied to the rotating container.

7. An apparatus for producing nanofibers, comprising:
a rotating container that is rotatably supported and is provided with a plurality of small holes disposed at a certain distance in a radial direction from the rotating axis, at least a portion of the rotating container, in the vicinity of the small holes, possessing conductivity;
rotation drive means for driving the rotating container to rotate;
a conductive collector that is disposed with a certain distance to the rotating container;
high voltage generating means for applying a high voltage between the rotating container and the collector;
polymer solution supply means for supplying a polymer solution, which is prepared by dissolving a polymeric substance in a solvent, into the rotating container; and
a control unit that controls the rotation drive means, the high voltage generating means, and the polymer solution supply means, wherein
while the rotating container is rotated at a prescribed speed by the control unit, the polymer solution is supplied into the rotating container, and a high voltage is applied between the rotating container and the collector.

8. The apparatus for producing nanofibers according to claim 6, wherein the rotating container is composed of a cylindrical container having the plurality of small holes on a circumferential surface thereof, and control means for keeping an amount of the polymer solution contained in the cylindrical container constant is provided.

9. An apparatus for producing a polymeric web wherein a polymeric web is produced by depositing the nanofibers produced by the apparatus for producing nanofibers according to claim 7 on a two-dimensionally extending collector.

10. The apparatus for producing a polymeric web according to claim 9, comprising sheet member moving means for moving a sheet member, on which the nanofibers are deposited, at a prescribed speed on and along the collector.

11. The apparatus for producing nanofibers according to claim 7, wherein the rotating container is composed of a cylindrical container having the plurality of small holes on a circumferential surface thereof, and control means for keeping an amount of the polymer solution contained in the cylindrical container constant is provided.
